(19) United States
(12) Patent Application Publication
(10) Pub. No.: US 2004/0249816 A1
(43) Pub. Date: Dec. 9, 2004

(54) Information communication apparatus, information communication method, and information recorded medium

(75) Inventor: Kenichiro Tada, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/858,383

(22) Filed: Jun. 2, 2004

(30) Foreign Application Priority Data
Jun. 3, 2003 (JP) P2003-157976

(51) Int. Cl. G06F 7/00

(52) U.S. Cl. 707/9

(57) ABSTRACT

An apparatus for information communication via a network between one and other devices, which includes: a HDD that pre-registers keyword and addressee information indicating address for communication with the other device in association with each other; a broadcast interface and a serial interface, each of which acquires desired contents information; a demultiplexer that extracts a pre-registered keyword from the acquired contents information; and a network interface that sends information about the keyword to an addressee having registered the keyword matching with the extracted keyword as correspondence data, based on the extracted keyword and the registered addressee information.

### BACKGROUND OF THE INVENTION

1. Field of the Invention

The present invention relates to an information communication apparatus and method for exchanging information via a network from one to other devices which have been mutually authenticated, and an information recorded medium on which an information communication program for such processing is recorded.

2. Related Art

Conventional information communication systems are based on personal computers (PCs) through which users exchange electronic mails using mail addresses and the like which they manage personally. Particularly, in recent years, many users employ electronic mails to exchange personal information such as their hobbies and tastes.

One such information communication system is disclosed in, e.g., JP-A-2001-331443, in which a server connected via a network such as the Internet is comprised of an interface to the network, computers for information processing, and their peripherals. The server registers a plurality of users of communication terminals as its members, and provides the registered members with information and permits them to exchange information.

However, these information communication systems known in the above art are operated, for example, based on PCs, and thus usually use keyboards and mice as information input device. It is thought difficult that technique of small input setting by such information input device is applied to control of home electric appliances. It would also be considered further difficult to replace such information input device with remote controllers.

Furthermore, in the invention disclosed in JP-A-2001-331443, the server, which has a database holding Specific information and personal information for information communication, is used to manage addressees of information. Thus, using this server, it would neither be easy to build an information communication system which handles authentication of communication terminals, registration of predetermined information, exchange of information among the communication terminals, and the like, nor does it allow the users to exchange information with ease.

The present invention has been obtained in consideration of the above circumstances, and it is one of the objects to provide an information communication apparatus and method, an information communication program and an information recorded medium capable of easily building a system for exchanging information among users who share hobbies and tastes, and simplifying the operation of inputting information.

### SUMMARY OF THE INVENTION

To solve the above issue, the invention of information communication apparatus according to claim 1 relates to an apparatus for information communication via a network between one and other devices which are mutually authenticated, said apparatus comprising:

a registration device which pre-registers keywords and addressee information indicating address for communication with said other device, in association with each other;

an acquisition device which acquires desired contents information;

an extraction device which extracts a pre-registered keyword from said acquired contents information; and

a sending device which sends information about said keyword to an addressee having registered said keyword matching with said extracted keyword as correspondence data, based on said extracted keyword and said registered addressee information.

The invention of information communication method according to claim 8 relates to a method for information communication via a network between one and other devices which are mutually authenticated, said method comprising the processes of:

pre-registering keyword and addressee information indicating addressee for communication with said other device, in association with each other;

acquiring desired contents information;

extracting a pre-registered keyword from said acquired contents information; and

sending information about said keyword to an addressee having registered said keyword matching with said extracted keyword as correspondence data, based on said extracted keyword and said registered addressee information.

The invention of information recorded medium according to claim 9 relates to an information recorded medium wherein a program is recorded in a manner readable by a computer, said program being for information communication via a network between one and other devices which are mutually authenticated by a computer, said program causing said computer to function as:

a registration device which pre-registers keyword and addressee information indicating addressee for communication with said other device, in association with each other;

an acquisition device which acquires desired contents information;

an extraction device which extracts a pre-registered keyword from said acquired contents information; and

a sending device which sends information about said keyword to an addressee having registered said keyword matching with said extracted keyword as correspondence data, based on said extracted keyword and said registered addressee information.

### BRIEF DESCRIPTION OF THE DRAWINGS

FIG. 1 shows the overall configuration of an information communication apparatus according to an embodiment;

FIG. 2 schematically illustrates a storage area of a RAM in the embodiment;

FIG. 3 illustrates the storage area of the RAM in the embodiment in detail;

FIG. 4 schematically illustrates information for storage in a HDD of the embodiment;

FIGS. 5A and 5B illustrate the data structure of service information SI in the embodiment;

FIG. 6 shows a display screen for the SI in the embodiment;

FIG. 7 shows a presentation screen to a manipulating user in the embodiment;

FIGS. 8A to 8C illustrate examples of how registered user names are displayed in the embodiment;

FIG. 9 illustrates an example of an e-mail template in the embodiment;

FIG. 10 illustrates an example of an e-mail message to be sent in the embodiment;

FIG. 11 illustrates an example of an e-mail message to be replied in the embodiment;

FIG. 12 is a flowchart showing a sending operation in the embodiment; and

FIG. 13 illustrates a plurality of terminals and a network in the embodiment.

### DESCRIPTION OF THE PREFERRED EMBODIMENT

An embodiment of the present invention will now be described with reference to the drawings.

Note that the following description is given of the embodiment in which an information communication apparatus of the invention is applied to AV (Audio Visual) equipment capable of receiving AV information distributed via digital broadcasting, such as BS (Broadcast Satellite) digital broadcasting.

Furthermore, in the following description, the AV information is broadcasted in conformity with the well known MPEG (Moving Picture Expert Group) 2 transport stream standard, the MPEG2 being well known in the art as a moving image compression technology standard.

Additionally, in the following description, “electronic mail” or “e-mail” means mail by which a document can be sent to a designated addressee similarly to mail sent and received by an Internet electronic mail service, and which has a mail format conforming to MIME (Multipurpose Internet Mail Extensions) standards (RFC1521, RFC1522 or RFC2045 to RFC2049) made public as standard mail format specifications by the ARPA Net.

(1) Overall Configuration and Operation

Next, the overall configuration and operation will be described of an information communication apparatus for exchanging information among a plurality of users.

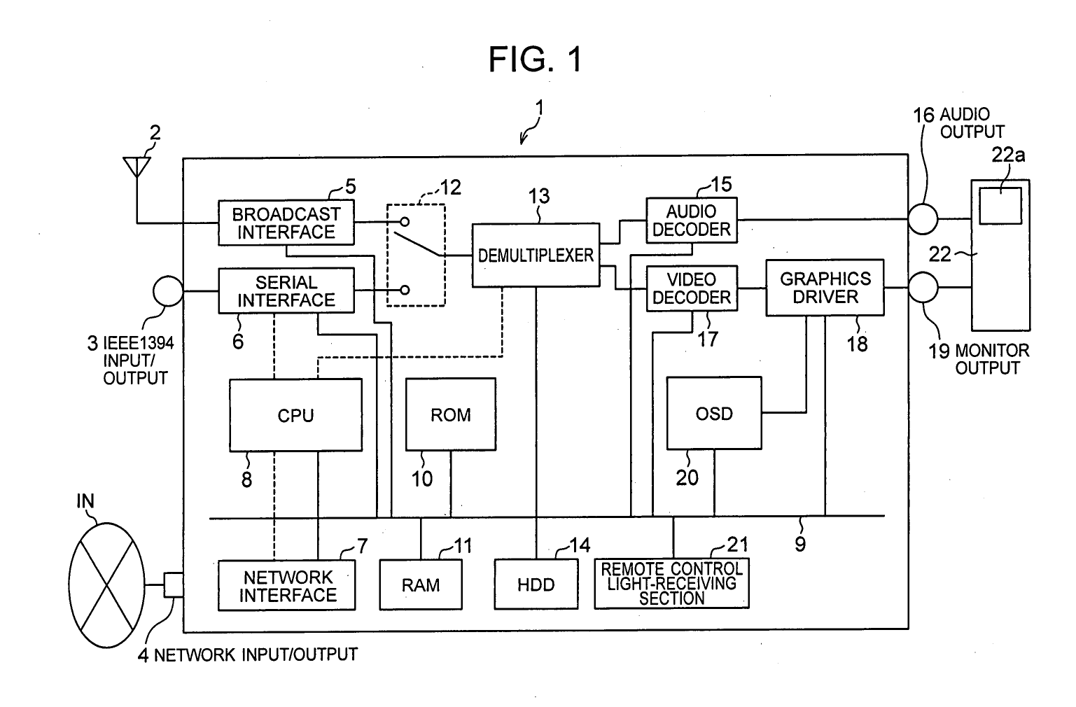

First, an explanation of the overall configuration and schematic operation of the information communication apparatus is made with reference with FIG. 1. FIG. 1 is a block diagram showing the overall configuration of an information communication apparatus according to this embodiment. In FIG. 1, although a CPU 8 controls all components within an information communication apparatus 1, only control portions relevant to this embodiment are shown for simplicity.

As shown in FIG. 1, the information communication apparatus 1 according to the embodiment has an antenna 2 for receiving digital broadcasting, an input/output port 3 for inputting/outputting information compliant with the IEEE (Institute of Electrical and Electronics Engineers) 1394 standards, and an input/output port 4 for inputting/outputting information to and from other devices via a communication network IN.

The information communication apparatus 1 also includes a broadcast interface 5 connected to the antenna 2 for acquiring contents information in digital broadcasting, a serial interface 6 connected to the input/output port 3 for acquiring contents information from IEEE1394standard-compliant information, a network interface 7 connected to the input/output port 4, and the CPU 8 for controlling the entire part of the apparatus, a bus 9, and a ROM 10 and a RAM 11 both of which are connected to the bus 9.

The information communication apparatus 1 is further provided with a switch 12 for selecting a signal from the broadcast interface 5 or a signal from the serial interface 6 based on a control signal from the CPU 8, a demultiplexer 13 to which this switch 12 is connected, a hard disk drive (HDD) 14, an audio decoder 15 connected to the demultiplexer 13, an audio output terminal 16 to which this audio decoder 15 is connected, a video decoder 17 connected to the demultiplexer 13, a graphics driver 18 connected to this video decoder 17, a monitor output terminal 19 connected to this graphic driver 18, an OSD (On-Screen Display) 20, and a remote control light-receiving unit 21. The apparatus 1 is electrically connected to a television (TV) 22 having a display screen 22a.

Note that, e.g., the broadcast interface 5 of this embodiment constitutes an acquisition device according to the present invention, and the serial interface 6 constitutes an acquisition device according to the present invention. Furthermore, e.g., the network interface 7 of the present embodiment constitutes a transmission device and a reception device according to the present invention, and the demultiplexer 13 constitutes an extraction device according to the present invention. Moreover, e.g., the HDD 14 of this embodiment constitutes a registration device and a storage device according to the present invention, and the RAM 11 of the embodiment constitutes a reception count storage device according to the present invention. And, e.g., the CPU 8 in this embodiment constitutes a generation device and a detection device of the present invention, and the OSD 20 of the embodiment constitutes a display control device according to the present invention.

Next, its operation will be outlined.

When the switch 12 selects from the broadcast interface 5 a signal for output to the demultiplexer 13, according to a control signal from the CPU 8, the broadcast interface 5 tunes to a signal from the antenna 2, and outputs it to the demultiplexer 13 as an MPEG-TS signal.

On the other hand, when the switch 12 selects from the serial interface 6 according to a control signal from the CPU 8, a signal for output to the demultiplexer 13, the serial interface 6 outputs to the demultiplexer 13 a signal from the input/output port 3 based on IEEE1394 standard as an input signal, and sends a command of IEEE1394 standard to the CPU8, and outputs a command through IEEE1394 standard from CPU8 and a response to the command.

The demultiplexer 13 separates the MPEG-TS signal, which is an output signal from the broadcast interface 5 or the serial interface 6 selected by the switch 12, into an audio signal and a video signal. As a result, the demultiplexer 13 outputs the audio signal to the audio decoder 15, and the video signal to the video decoder 17, and at the same time, extracts Program Specific Information/Service Information (PSI/SI) in the MPEG-TS signal which is contents information, and transfers necessary service information SI to the CPU 8.

That is, of the MPEG-TS signal received, the demultiplexer 13 extracts only data necessary for subsequent stage. More specifically, the demultiplexer 13 has a function of routing the packet data of a video signal to downstream stage by designating a PID (Packet ID) carrying that video signal to be decoded out of digital broadcast streams transmitted in the MPEG-TS format. Similarly, the demultiplexer 13 also has a function of extracting a PID when the PID is set which carries an audio signal, other additional data, and other data for use by the CPU 8.

Note that the program specific information PSI provides such information as to allow the TV to automatically demultiplex and decode various multiplexed program streams. Furthermore, the service information SI represents various data of digital broadcast programs.

Moreover, the audio and video signals separated by the demultiplexer 13 are decoded by the audio decoder 15 and the video decoder 17, respectively. And, the audio signal from the audio output terminal 16 is supplied to a speaker unit (not shown) of the TV 22, and the video signal is supplied to the graphics driver 18. The graphics driver 18 mixes data obtained from the video decoder 17 and the OSD 20 to create a screen image for output to the monitor output terminal 19, and outputs the created image to the display screen 22a of the TV 22. Here, the OSD 20 prepares a signal for superimposition on a video signal decoded by the video decoder 17, according to instructions from the CPU 8, and outputs the prepared signal to the graphics driver 18.

The ROM 10 stores an overall program for the information communication apparatus 1, which program uses the RAM 11 as its work area. As will be described later, the RAM 11 stores necessary mail addresses and the like for sending e-mail.

The HDD 14 holds data and the like, such as a database, which should remain recorded independently of whether the power of the information communication apparatus 1 is turned on or off. The HDD 14 receives from the CPU 8 instructions for writing and reading data, and data storage position information of that time. Particularly, the HDD 14 stores registered user names, a manipulating user file having data including mail addresses and keywords of the registered user names, and registered user files, as mentioned later.

The CPU 8 is connected to the serial interface 6, the network interface 7, and the demultiplexer 13, and thus can receive instruction signals therefrom. The CPU 8 is also configured to acquire and output data from and to various parts of the apparatus via the bus 9.

The remote control light-receiving section 21 receives signal light such as an infrared beam emitted from a remote controller, i.e., means by which a user inputs operation instructions, to input a manipulating signal, and transfers an operation command based on the manipulating signal to the CPU 8.

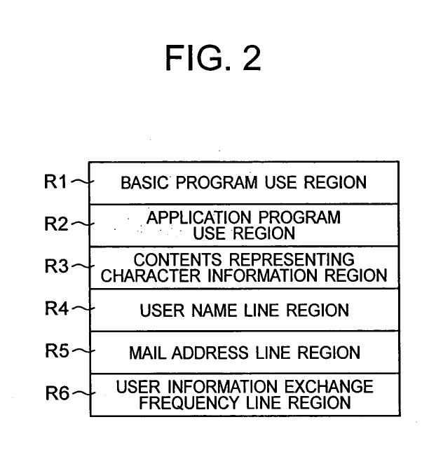

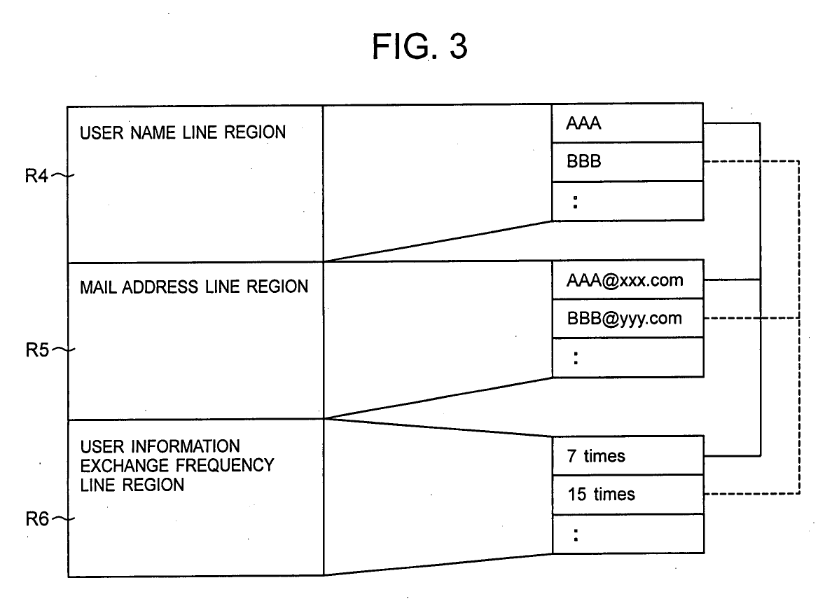

Referring to FIGS. 2 and 3, a storage area of the RAM 11 in such information communication apparatus 1 will be described. FIG. 2 is a view which schematically shows a storage area of RAM according to the present invention, and FIG. 3 is a view which shows in detail a storage area of RAM according to the present embodiment.

As shown in FIG. 2, the storage area of the RAM 11 consists of a basic program region R1, an application program region R2, a contents representing character information region R3, a user name line region R4, a mail address line region R5, and a user information exchange frequency line region R6.

The basic program region R1 and the application program region R2 temporarily store programs and related data necessary for various operations of the information communication apparatus 1. The user name line region R4, the mail address line region R5, and the user information exchange frequency line region R6 include recordings of various data necessary for sending e-mail, as shown in FIG. 3, specifically, user names, mail addresses, and user information exchange frequencies, respectively, related to those registered user files in which keyword(s) is shared in common, as will be described later.

As shown in FIG. 3, e.g., recorded in the user name line region R4 are user names of candidates to which e-mail 25 would be sent at the time of sending an e-mail, and recorded in the mail address line region R5 are e-mail addresses recorded in the user name line region R4. Also, recorded in the user information exchange frequency line region R6 are information exchange frequencies so far for users recorded in the user name line region R4. Note that the term “information exchange frequency” represents the number of times at which a user has received a reply to the information provided by sending e-mail, and is used when the registered user of sending an e-mail is set, as will be described later.

Recorded in the contents representing character information region R3 is, e.g., event information contained in the service information SI of the PSI/SI in the Association of Radio Industries and Businesses (ARIB) standards, the PSI/SI being in the MPEG-TS signal of a digital broadcast extracted by the demultiplexer 13.

Specifically, as mentioned later, recorded in the contents representing character information region R3 are character information event_name char (8 bits) representing a program name (title) and text_char (8 bits) summarizing a program, which are contained in an event information table (EIT) of the service information SI.

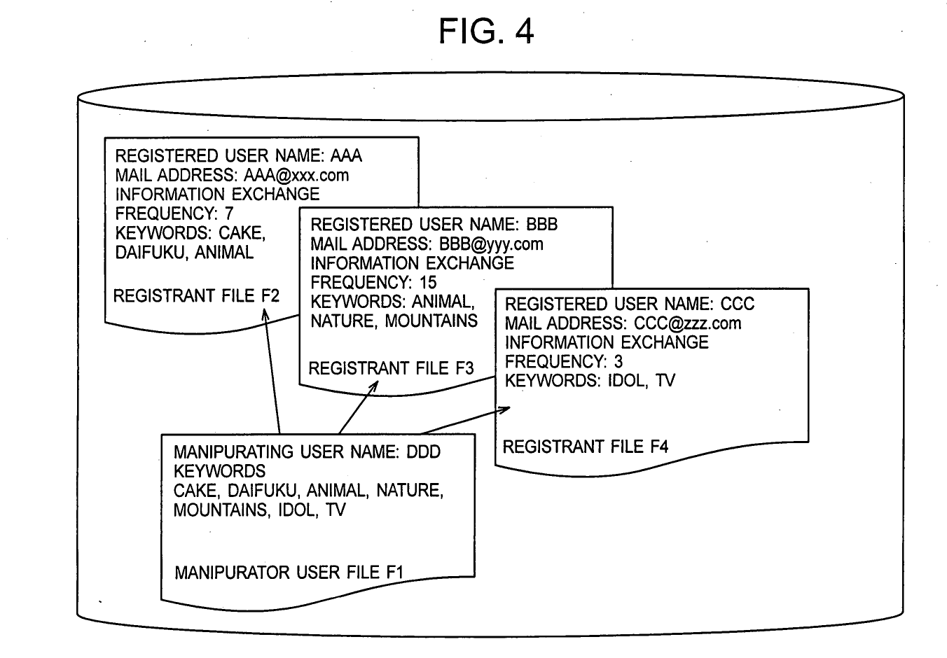

Referring next to FIG. 4, the HDD 14 in the information communication apparatus 1 will be described. FIG. 4 is a view which schematically shows one example of information stored in the HDDl4.

The HDD 14 in the information communication apparatus 1 stores information which is used by the basic and application programs and which need to be rewritten regardless of on or off condition of power supply.

In the following description, as shown in FIG. 4, a user who manipulates the information communication apparatus 1 shown in FIG. 1 will be called a “manipulating user”, and other users who can exchange information with the manipulating user will be called “registered users”. Note that a plurality of manipulating users may be set to a single information communication apparatus 1. Also, in the present embodiment, e.g., an information communication apparatus manipulated by the manipulating user corresponds to one of devices of the present invention, and information communication apparatuses manipulated by the registered users correspond to the other of devices of the present invention, and the respective apparatuses have been authenticated so that they are intercommunicatable in advance.

The database in the HDD 14 holds in related condition registered user names each being a user's real name or alias such as his/her nick name, used to send an e-mail, individual addressee information such as mail addresses corresponding to the registered user names, information exchange frequency each indicating the number of times at which a manipulating user receives a reply for the information provided by sending an e-mail to each registered user, and keywords as to information representing hobbies and tastes and shared among registered users.

For example, the database in the HDD 14 stores a manipulating user file F1, and registered user files F2, F3, and F4, as shown in FIG. 4. The manipulating user file F1 includes a manipulating user name “DDD”, and his/her keywords “cakes, daifuku (Japanese sweet), animals, nature, mountains, idols, TV”. The registered user file F2 includes a registered user name “AAA”, his/her mail address “AAA@xxx.com”, information exchange frequency “7”, and keywords “cakes, daifuku, animals”. The registered user file F3 includes a registered user name “BBB”, his/her mail address “BBB@yyy.com”, information exchange frequency “15”, and keywords “animals, nature, mountains”. Furthermore, the registered user file F4 includes a registered user name “CCC”, his/her mail address “CCC@zzz.com”, information exchange frequency “3”, keywords “idols, TV”.

Note that the keywords saved in the manipulating user file F1 and registered user files F2, and F3 represent hobbies and tastes of manipulating user or each registered user. Furthermore, in the manipulating user file F1 are held keywords which the manipulating user shares with the registered users, and preferably, they are saved in such an optimized manner as making no duplication of keywords. These keywords are designed to be registered beforehand by the remote controller or the like. By designating a keyword and searching that keyword from the registered keywords, access can be made such that user(s) who has registered that keyword can be specified.

(2) Acquisition of Contents Information

Next, an operation during reception of BS digital broadcasting, i.e., an operation of acquiring contents information, in this embodiment, will be described.

When an instruction for receiving, e.g., a service ID (No. S) of a BS digital broadcast is acquired from the remote controller (not shown) via a user manipulation, the CPU 8 instructs the broadcast interface 5 to receive a frequency for receiving an MPEG-TS signal containing the service ID (No. S) which is contents information.

Then, the CPU 8 outputs a control signal such that the demultiplexer 13 separates the MPEG-TS signal of the service ID (No. S). The demultiplexer 13 analyses Program Association Table/Program Map Table (PAT/PMT) in order to separate the MPEG-TS signal, acquires the packet IDs of audio and video signals necessary for decoding the service ID (No. S), and outputs the separated audio and video signal data to the audio decoder 15 and the video decoder 17, respectively.

Here, the PAT and PMT constitute PSI (Program Specific Information) data. The PAT represents the location of program map table corresponding to each service in multiplicity, i.e., the packet ID of transport stream packets. The PMT specifies and represents the location of stream constituting the each service, and the location of program clock reference (PCR) field of the service.

Successively, the CPU 8 gives the audio and video decoders 15 and 17 a decoding start instruction signal. When the audio decoder 15 is given the decoding start instruction signal, the audio decoder 15 outputs decoded audio data via the audio output terminal 16. On the other hand, the video decoder 17 outputs a decoded video signal from the monitor output terminal 19 via the graphics driver 18 which has not yet been instructed by the CPU 8. In this way, AV (Audio Visual) information distributed via digital broadcasting can be acquired as contents information.

(3) Acquisition of Keyword(s) from Contents Information

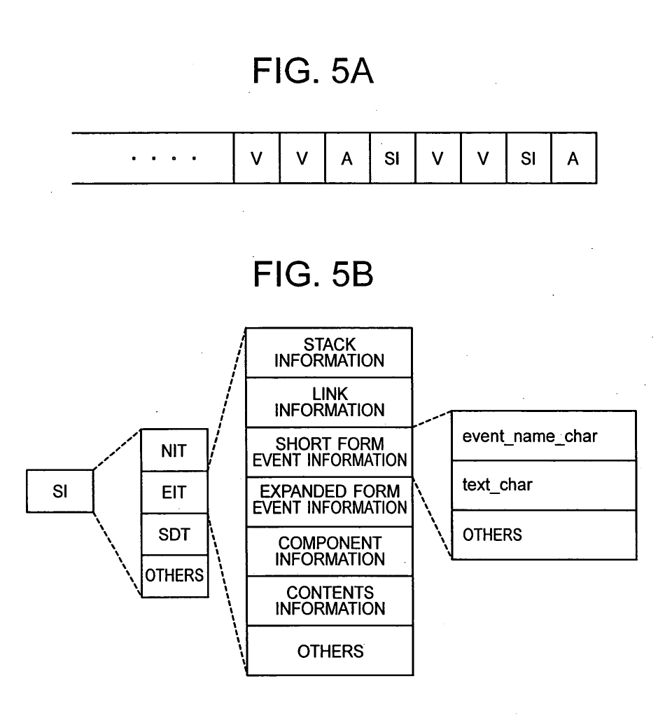

Next, of the PSI/SI which contains video information (V) and audio information (A) in an MPEG-TS signal distributed by BS digital broadcasting and which is in the ARIB standards as shown in FIG. 5A, service information SI as contents guidance information will be described with reference to FIG. 5B. The PSI data provides information by which a TV can automatically demultiplex and decode various multiplexed program streams.

As shown in FIG. 5B, the service information SI consists of a network information table (NIT), an event information table (EIT), a service description table (SDT), and other tables. The event information table (EIT) includes event-related and program-related data such as event names, and their starting times and duration. By use of each of these items of information, different kinds of event information can be transmitted. The term “event” used herein means a digitally broadcast program.

The event information table (EIT) includes stack information used as, e.g., dummy information for stuffing the table, link information for identifying a service to be provided when a viewer requests additional information related to a specific object described in the SI system, short event information giving the name of an event and a summary of the event in a textual form, extended event information providing a detailed description of the event used in addition to the short event information, component information indicating the type of a component and used also for representing elementary streams in the form of characters, contents information indicating the genre of an event, and other information.

The short event information includes event_name_char representing the name of a program (title), text_char summarizing the program, and others. Each of the event name char and text char is 8-bit information.

Therefore, in this embodiment, e.g., by extracting event_name_char and text_char from short event information, a keyword as to information representing hobbies and tastes and shared with registered users can be obtained. That is, for event_name_char and text_char, character strings C are displayed, from which a keyword can be picked up, as will be described later.

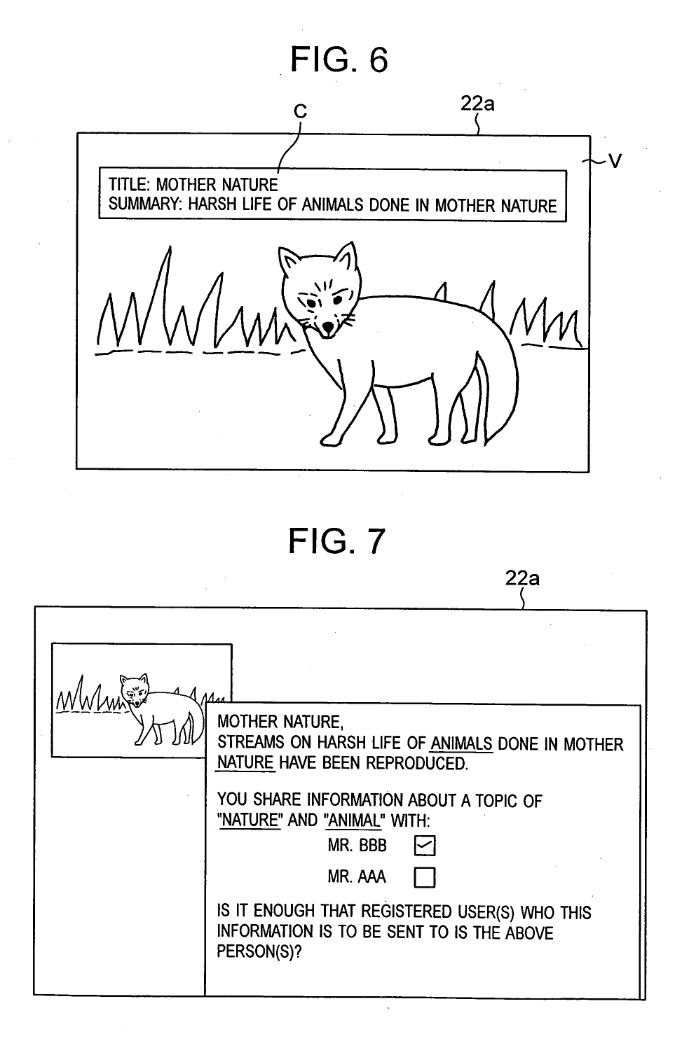

Note that event_name_char and text_char are usually arranged to be displayed on a TV screen or the like during selection of an event or during viewing of an event. For example, on the display screen 22a of the TV 22, character lines C, such as “Title: Mother Nature” and “Summary: Harsh life of animals done in Mother Nature” are displayed, together with a picture V, as shown in FIG. 6.

(4) Search for Keyword(s)

Next, an operation of storing character lines for searching keyword(s) during reception of the broadcast will be described.

During the above operation, the CPU 8 instructs the demultiplexer 13 to store, at a predetermined position of the RAM 11, data, i.e., the name of a program (event_name_char) and a description of the program. (text_char) in the short event information (short_event_descriptor), upon reception of an event information section (event_information_section) contained in the event information table EIT, of service information SI. Thereafter, various event data designated by the demultiplexer 13 is received, whereby the event data is stored in the application program use region R2 of the RAM 11.

The CPU 8 also receives a predetermined signal, whereby it reads the data from the application program use region R2, to store the name of the program (event_name_char) and the description of the program (text_char) contained in the short event information (short_event_descriptor), in the contents representing character information region R3 of the RAM 11.

Next, an operation of searching keyword(s) performed when the event ends during reception of the broadcast will be described.

It is known in the art that one can recognize the end of an event during reception of a broadcast from PSI/SI. When the event is brought to an end, a comparison is made between the character lines stored in the contents representing character information region R3 of the RAM 11 and a group of keywords pre-stored in the manipulating user file F1 of the HDD 14. If any matched, i.e., shared character lines (keyword) is found, then a file in which that keyword is registered is searched from the registered user files F2, F3, and F4, using relational database technology for acquiring/managing respective associated data. Then, each information of the associated registered user name, mail address, and information exchange frequency is stored in the user name line region R4, the mail address line region R5, and the information exchange frequency line region R6 of the RAM 11 from the registered user files F2, F3, and F4 in which that keyword is registered, respectively, as mentioned above. Note that if applicable in the present operation, a plurality of registered user names, mail addresses, and information exchange frequencies may be recorded in the respective regions R4, R5, and R6.

(5) Display Operation when E-Mail is Sent

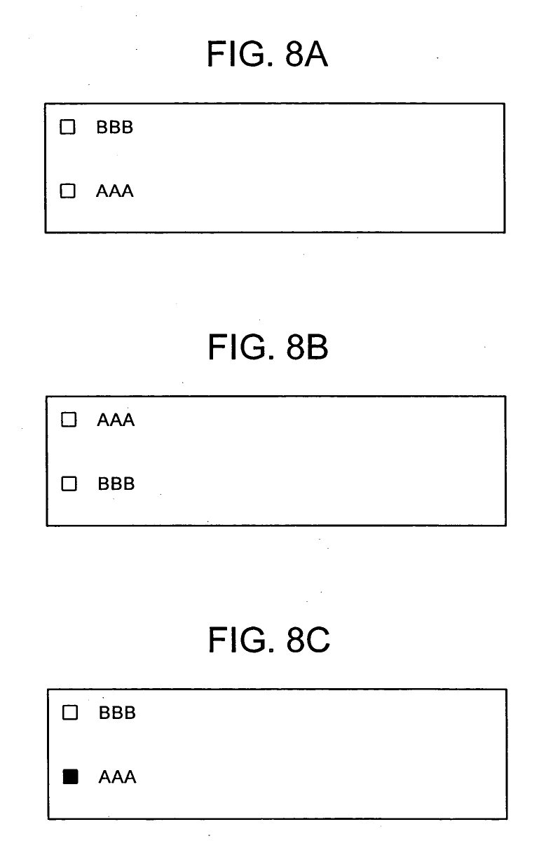

Referring next to FIGS. 7 and 8, an operation of displaying the registered user names and mail addresses stored, and selection/non-selection will be described. FIG. 7 is a view of presenting screen to a manipulating user in the embodiment, and FIG. 8 is a view of example of showing registered users in the present embodiment.

Through the operations up to this, data such as shown in FIG. 3 has been stored in the regions R4, R5, and R6 of the RAM 11, as mentioned above. At this point, in order to display a user name on the display screen using the OSD 20, information about information exchange frequency in which a maximum value is stored is first obtained from the user information exchange frequency line region R6. The user name referenced by that index is obtained from the user name line region R4. Then, that user name and a selection box indicating whether or not the subsequent operation is performed for that user are structured as graphic data by using the OSD 20, and displayed on the screen via the graphics driver 18 as shown in FIG. 7.

Successively, the previously obtained value is excluded, the information exchange frequency in which a maximum value is stored is obtained, and another user name is similarly obtained from the user name line region R4. By each operation, the order of the display of the user names can be arranged by a value stored in the user information exchange frequency line region R6.

In the selection box to user, expression indicationg selection by default can be used, if the value stored in the region R6 is absolutely large, as shown in FIG. 8A, or in the selection box to user of ½ or less than the initially obtained maximum value, expression indicating non-selection by default can be used.

When a plurality of keywords are found in the contents representing character information region R3, the order of the displaying may be changed, as shown in FIG. 8B, according to the number of common keywords shared by the registered user files F2, F3, and F4. As to a user who has received information but has not replied to the information sent so much as expected, a non-selection is displayed in a sending list, as shown in FIG. 8C.

At this point, the user may make a selection or a non-selection by manipulating the selection boxes via the remote controller.

Thus, in this embodiment, the information exchange frequency information is detected, the information exchange frequency in which a maximum value is stored is updated based on the detected result, whereby the information exchange frequency is stored for each other user name, and the display form displayed by the OSD 20 is changed based on such information exchange frequencies, for example, as shown in FIG. 8B.

(6) Method of Sending/Receiving Information and Setting of Information Exchange Frequencies

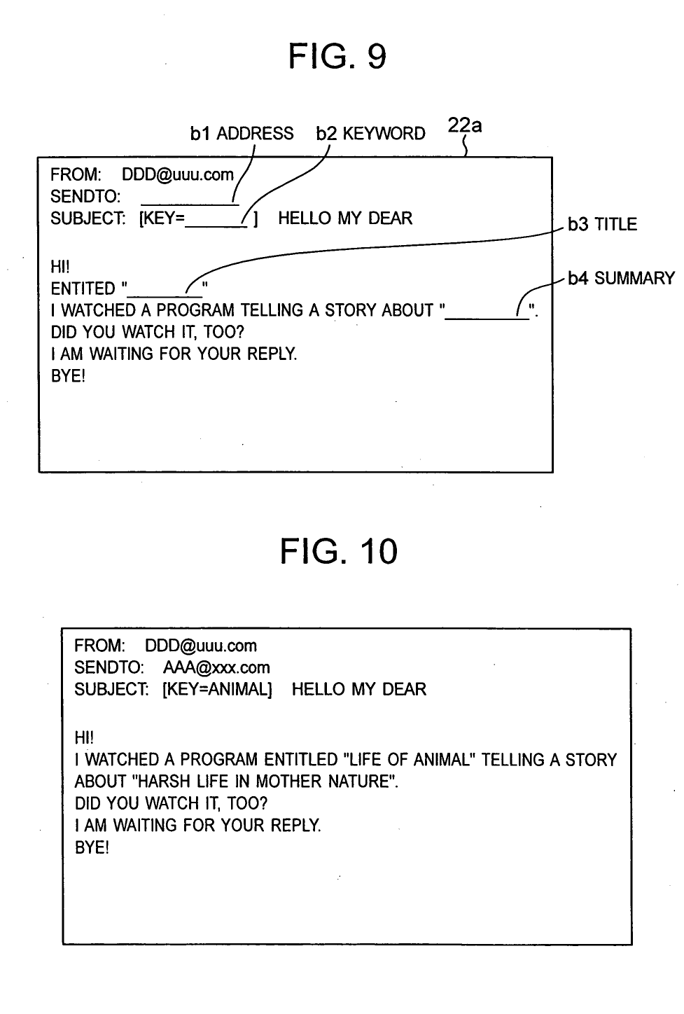

Referring next to FIGS. 9 to 11, a method of sending/receiving information to/from a user selected through the selection boxes will be described.

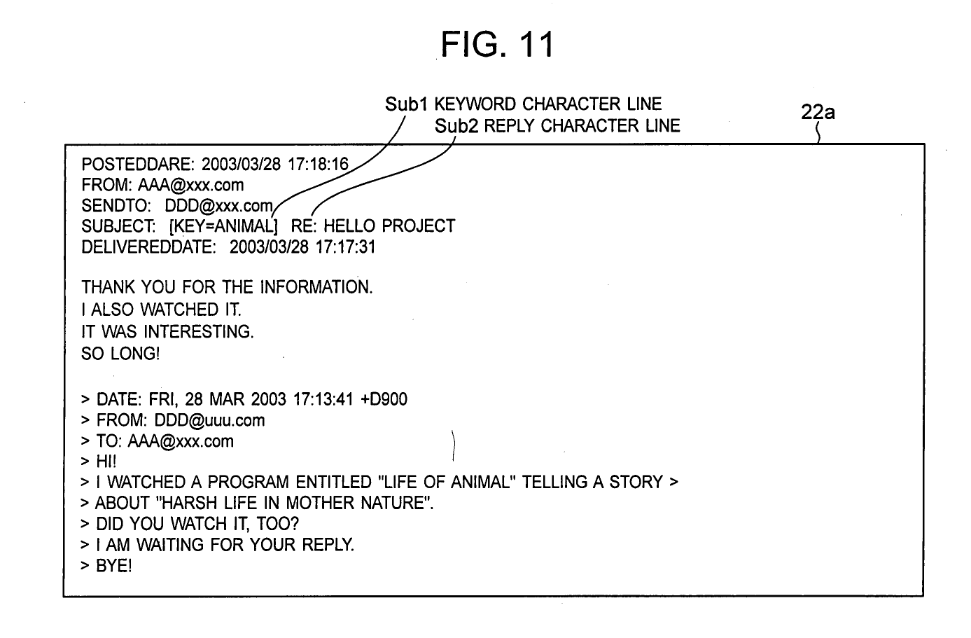

FIG. 9 illustrates an example of an e-mail template in the embodiment, FIG. 10 illustrates an example of an e-mail message to be sent in the embodiment, and FIG. 11 illustrates an example of an e-mail message to be replied in the embodiment.

First, an operation performed when e-mail is sent will be described.

The user name selected by the above operation is obtained, and a mail message is composed by using the keyword(s) used in the operation of this time and contents representing character information in the contents representing character information region R3. A template of this mail is saved in the HDD 14 beforehand. In the mail template, blanks are provided as in the display screen 22a in FIG. 9. For sending the e-mail, an address section b1, a keyword section b2, a title section b3, and a summary section b4 are allocated to these blanks, respectively.

As shown in FIG. 10, for example, if the keyword is “animals”, the event_name data is “life of animals” and the text_char data is “harsh life in Mother Nature”., and if the mail address of the selected user name is AAA@xxx.com, then the CPU 8 enters the mail address AAA@xxx.com corresponding to the user name selected in the address section b1, enters the keyword “animals” in conformity with the keyword b2, enters the event_name data “life of animals” stored in the contents representing character information region R3 to the title section b3, and enters the text_char data “harsh life in Mother Nature” stored in the contents representing character information region R3 to the summary section b4, to complete the message of the mail. The CPU 8 then sends this mail message as correspondence data via the network interface 7 according to a known mail sending process.

Next, an operation performed when an e-mail is received will be described.

The arrival of an e-mail message is recognized after the network interface 7 of FIG. 1 receives a signal from the network IN and the CPU 8 performs a process of recognizing its arrival from the signal. In this e-mail message, the CPU 8 searches whether the message is a reply to the keyword sent, as shown in FIG. 11, from the character lines in the e-mail. Here, the title of the replied mail is headed by a keyword character line Sub1 indicating that the e-mail is sent based on the keyword, and then displayed by a reply character line Sub2 “RE:”, whereby the CPU 8 can recognize that the received e-mail is a reply.

After recognition of obtaining of the reply, the CPU 8 searches a mail address matching with the mail address indicated in the “From:” section in the e-mail, from the registered user files F2, F3, and F4 in the database of the HDD 14, and increments the information exchange frequency in the matched file by 1. By one-increment of number of information exchange frequency in this way, the information exchange frequency value for use in order of display of the user names is changed for the next time at which information will be exchanged.

(7) Flowchart Showing Sending Operation

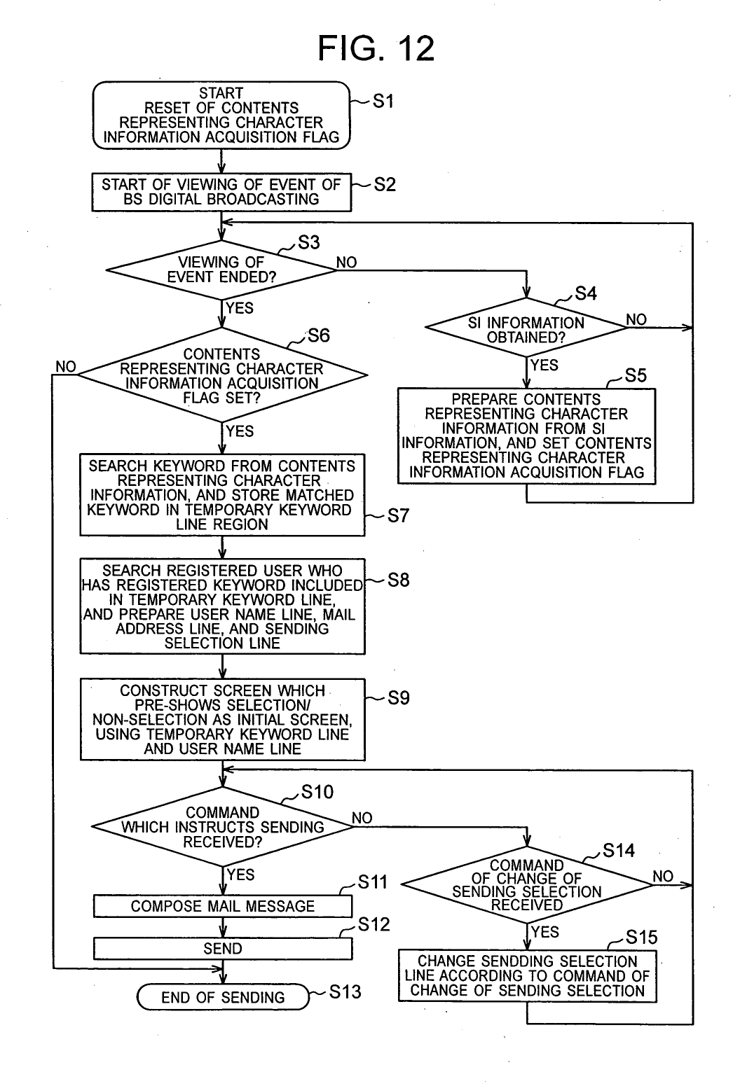

Turning now to a flowchart shown in FIG. 12, a sending operation according to this embodiment will be described. FIG. 12 is a flowchart showing a sending operation of e-mail according to the embodiment.

As shown in FIG. 12, the CPU 8 resets a contents representing character information acquisition flag (step S1), and thereafter starts viewing a BS digital broadcast event (program) (step S2). Then, the CPU 8 determines whether or not the viewing of the event has been brought to an end from the PSI/SI (step S3) and, if not end (step s3; NO), it goes to step S4, and if end (step s3; YES),the CPU 8 determines whether or not the SI information has been obtained (step S4).

Next, if it is determined by the CPU 8 that the SI information has been obtained (step S4; YES), the CPU 8 creates contents representing character information from the SI information, and then returns to step S3 after setting the contents representing character information acquisition flag (step S5). If the CPU 8 determines that the SI information has not been obtained (step s4; NO), the CPU 8 directly returns to step S3.

When the CPU 8 determines that the viewing of the event has been terminated (step S3; YES), the CPU 8 checks whether or not the contents representing character information acquisition flag has been set (step S6). If it is determined that the flag has not been set (step S6; NO), the CPU 8 ends the sending operation. If the CPU 8 determines that the flag has been set (step S6; YES), the CPU 8 searches a keyword from the contents representing character information recorded in the contents representing character information region R3 of the RAM 11, and stores the matched keyword in a temporary keyword line region in the application program use region R2 (step S7).

Next, the CPU 8 searches a registered user who has registered the keyword contained in the temporary keyword line region, and creates a user name line, a mail address line, and a sending selection line (step S8). And, the CPU 8 constructs a screen which pre-shows selection/non-selection as an initial screen, using the temporary keyword line and the user name line (step S9).

The CPU 8 further determines whether or not a sending instruction command has been received (step S10), and, if having received the command, it prepares and sends a mail message as shown in FIG. 10 as correspondence data, and then, it ends this process (steps S12, S13).

On the other hand, if it is determined that the CPU 8 has not received the sending instruction command (step S10; NO), the CPU 8 determines whether or not a sending selection changing command is received (step S14), and, if it is determined that the CPU 8 has received the sending selection changing command (step s14; YES), the CPU 8 changes the sending selection line according to the sending selection changing command, and then, it returns to step S10. If it is determined that the CPU 8 has not received the sending selection changing command (step S14; NO), the CPU 8 directly returns to step S10. By performing the series of steps, the sending operation is terminated.

(8) Example of Application to a Plurality of Terminals

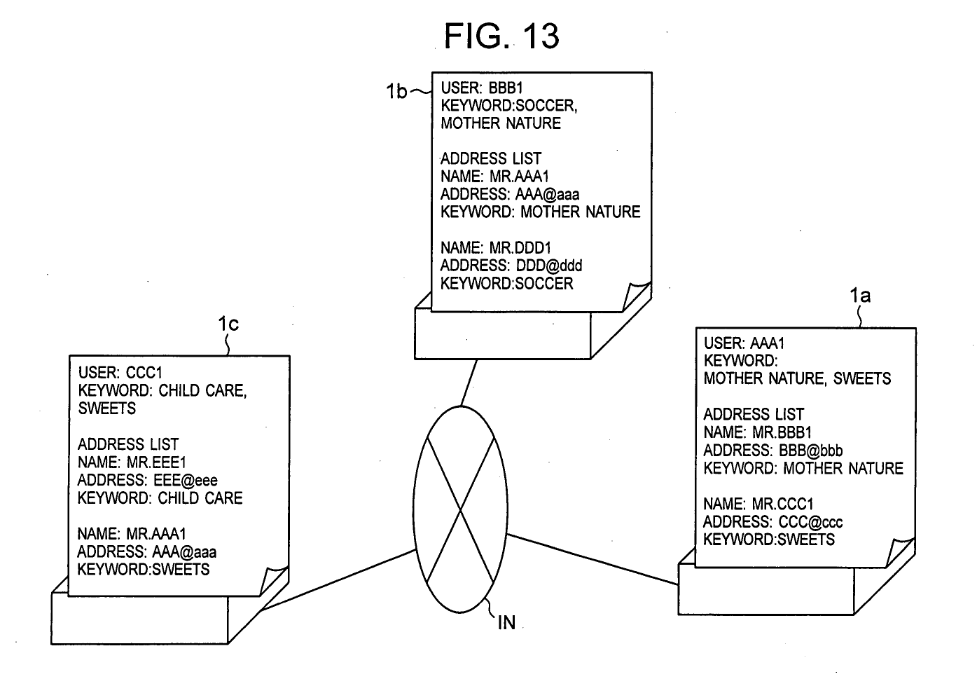

FIG. 13 shows an example in which this embodiment is applied to a plurality of terminals. FIG. 13 is an explanatory view which shows a plurality of terminals and a network in the embodiment.

As shown in FIG. 13, users have information communication apparatuses 1a, 1b, and 1c, each having a similar construction as that of the above embodiment, and these apparatuses 1a,1b,and 1c have been mutually authenticated to communicate information via the network IN.

That is, saved in the HDD of the information communication apparatus 1a are a user AAA1, keywords “Mother Nature” and “sweets”, and saved as an address list are an address of Mr.BBB1:BBB@bbb with its keyword “Mother Nature”, and an address of Mr.CCC1:CCC@ccc with its keyword “sweets”.

Saved in the HDD of the information communication apparatus 1b are a user BBB1, keywords “soccer” and “Mother Nature”, and saved as an address list are an address of Mr.AAA1:AAA@aaa with its keyword “Mother Nature”, and an address of Mr.DDD1:DDD@ddd with its keyword “soccer”.

Saved in the HDD of the information communication apparatus 1c are the user CCC1, keywords “child care” and “Mother Nature”, and saved as an address list are an address of Mr. EEE1:EEE@eee with its keyword “child care”, and the address of Mr. AAA1:AAA@aaa with its keyword “sweets”.

In this way, the user AAA1 matches with the user BBB1 in terms of the keyword “Mother Nature”, and matches with the user CCC1 in terms of the keyword “sweets”. The user BBB1 matches with the user AAA1 in terms of the keyword “Mother Nature” and matches with the user DDD1 in terms of the keyword “soccer”. Furthermore, the user CCC1 matches with the user EEE1 in terms of the keyword “child care” and matches with the user AAA1 in terms of the keyword “sweets”.

Therefore, in this example, common keywords are registered in the respective apparatuses 1a, 1b, and 1c similarly to the above embodiment, and keywords are extracted from information associated with the viewing of broadcasting or the like, whereby the information is communicated using means, such as e-mail, for those users sharing the same keyword(s).

As described in the foregoing, according to this embodiment, keywords and address information indicating the addressees for communication with other apparatuses are registered as being associated with one another beforehand. Then, desired contents information is acquired, and a pre-registered keyword is extracted from the acquired contents information, to allow information related to the keyword to be sent as communication message data to the addressees who have registered the keyword in conformity with the extracted keyword according to the extracted keyword and the registered address information. As a result, a system can be easily constructed, which allows users who share the same or similar hobbies and tastes to communicate information, and the operation of inputting information can be simplified.

Furthermore, according to this embodiment, there are provided the HDD 14 that pre-stores template information indicating predetermined character lines of a correspondence document when a user sends correspondence data based on addressee information indicating an e-mail address, and the CPU 8 that generates correspondence data based on the template information, and the network interface 7 sends the generated correspondence data, whereby the operation of inputting information can be simplified.

Furthermore, according to this embodiment, when communicating correspondence data with a plurality of other devices, there are provided the network interface 7 that receives correspondence data replied by the other device based on correspondence data sent via the network interface 7, and the CPU 8 that detects a receiving count indicating how many times the correspondence data replied by the other devices is received. The network interface 7 determines an addressee to be sent based on the receiving count and an extracted keyword, and sends information related to the keyword as correspondence data. As a result, the level of priority for sending e-mail can be changed based on the reply counts from the addressees' devices, whereby the operation of inputting information can be further simplified.

Moreover, according to this embodiment, the receiving count is stored in the RAM 11 for each of a plurality of other devices after updated according to the detection result obtained by the CPU 8 that detects correspondence data reception counts replied from the other devices, and how each addressee is displayed on the OSD 20 is altered based on the stored receiving count. Selection of address to be sent becomes easy, whereby the operation of inputting information can be further simplified.

The present invention is not limited to the above embodiment, but may be changed and modified in various ways. For example, while video signals and the like are acquired by reception of electric waves such as BS digital broadcasting in the above embodiment, it may also be designed such that a manipulating user searches desired video contents from WWW (World Wide Web) site and enjoys its viewing by streaming, then extracts keyword(s) from the title and summary of that video contents, and searches the name of a registered user who shares information in terms of that keyword, and displays the registered user name and makes the manipulating user select whether or not to send information, and if the manipulating user selects to send information, the information to be sent is constructed, and the information is sent as correspondence data.

Furthermore, while video signals and the like are acquired by receiving electric waves such as BS digital broadcasting, other electric waves such as analog TV broadcasting, contents information such as video signals from Video-on-Demand (VOD) servers via the Internet, cable televisions (CATVs) or exclusive lines and its contents guidance information may also be acquired, or contents information recorded on recording media such as DVD (Digital Versatile Disc) and HDD may also be read and acquired together with its contents guidance information.

Additionally, while an explanation has been made in case where the HDD 14 is used as a recording medium in the above embodiment, various other recording media including DVD and flash memory in which information is rewritable may also be used.

While the example in which keyword-related information is first sent and an addressee's device thereafter replies has been described in the above embodiment, the invention is likewise applicable to an apparatus that only sends information to addressee(s) having registered a matched keyword.

While infrared radiation from the remote controller is received by the remote control light-receiving section 21 to input an operation instruction in the above embodiment, operation instructions may also be inputted through, e.g., voice synthesis technology.

Furthermore, a program corresponding to the flowchart of FIG. 12 is recorded on an information recording medium such as a flexible disc or a hard disk, or the program is recorded after acquisition via a network such as the Internet, and thereafter the program is read from a general-purpose microcomputer or the like for execution, whereby the microcomputer may be made to function as the CPU 8 according to the above embodiment.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No.2003-157976 filed on Jun. 3, 2003, including specification, claims, drawings, and abstract is incorporated herein by reference in its entirety.

What is claimed is:

1. An apparatus for information communication via a network between one and other devices which are mutually authenticated, said apparatus comprising:
a registration device which pre-registers keywords and addressee information indicating address for communication with said other device, in association with each other;
an acquisition device which acquires desired contents information;
an extraction device which extracts a pre-registered keyword from said acquired contents information; and
a sending device which sends information about said keyword to an addressee having registered said keyword matching with said extracted keyword as correspondence data, based on said extracted keyword and said registered addressee information.

2. An apparatus according to claim 1, wherein said registration device registers said keywords which are character lines representing hobbies and tastes.

3. An apparatus according to claim 1, wherein when said contents information acquired by said acquisition device contains at least contents guidance information indicating guidance of said contents information, said extraction device extracts a keyword of said contents information based on said contents guidance information.

4. An apparatus according to claim 1, wherein
when said correspondence data is sent via electronic mail used as groupware in which a network is formed with a plurality of devices, said registration device registers mail addresses indicating addressees of said electronic mail as said addressee information.

5. An apparatus according to any one of claims 1, comprising:
a storage device which pre-stores template information indicating predetermined character lines of a correspondence document in said correspondence data; and
a generation device which generates said correspondence data based on said template information, wherein said sending device sends said generated correspondence data,
when the correspondence data is sent based on the address information.

6. An apparatus according to any one of claims 1, comprising:
a receiving device which receives correspondence data replied by said other device based on said correspondence data sent by said sending device; and
a detection device which detects the number of times at which correspondence data replied from said other device is received,
wherein said sending device determines said addressee based on said reception count and the extracted keyword, to send said information about said keyword as said correspondence data,
when said correspondence data is communicated with said plurality of other devices.

7. An apparatus according to claim 6, comprising:
a reception count storage device which updates said reception count according to a result of detection performed by said detection device, and stores said reception count for each of said plurality of other devices; and
a display control device which changes a form for displaying addressee based on said stored reception counts.

8. A method for information communication via a network between one and other devices which are mutually authenticated, said method comprising the processes of:
pre-registering keyword and addressee information indicating addressee for communication with said other device, in association with each other;
acquiring desired contents information;
extracting a pre-registered keyword from said acquired contents information; and
sending information about said keyword to an addressee having registered said keyword matching with said extracted keyword as correspondence data, based on said extracted keyword and said registered addressee information.

9. An information recorded medium wherein a program is recorded in a manner readable by a computer, said program being for information communication via a network between one and other devices which are mutually authenticated by said computer, said program causing said computer to function as:
a registration device which pre-registers keyword and addressee information indicating addressee for communication with said other device, in association with each other;
an acquisition device which acquires desired contents information;
an extraction device which extracts a pre-registered keyword from said acquired contents information; and
a sending device which sends information about said keyword to an addressee having registered said keyword matching with said extracted keyword as correspondence data, based on said extracted keyword and said registered addressee information.
